(19) United States
(12) Patent Application Publication
(10) Pub. No.: US 2006/0233940 A1
(43) Pub. Date: Oct. 19, 2006

(54) Confectionary product employing a syrupless coating of powderized edible polyols with negative heat of solution

(75) Inventors: Robert J. Huzinec, Hummelstown, PA (US); Thomas J. Carroll, Mechanicsburg, PA (US); Brian J. Paul, Millersburg, PA (US)

Correspondence Address: Leopold Presser, Scully, Scott, Murphy & Presser, Ste.300, 400 Garden City Plaza, Garden City, NY, 11530, US

(73) Assignee: HERSHEY FOODS CORPORATION, HERSHEY, PA (US)

(21) Appl. No.: 11/403,451

(22) Filed: Apr. 13, 2006

Related U.S. Application Data
(60) Provisional application No. 60/671,742, filed on Apr. 15, 2005.

(51) Int. Cl. A23G 3/00

(52) U.S. Cl. 426/660

(57) ABSTRACT

The present invention is directed to a confectionary item comprising: (a) a tackified matrix core upon which a matrix of non-homogenous powdered materials is formed by applying: (b) at least one deposit of binder that adheres to the gelatin flavored matrix core; (c) a powdered deposit of edible water soluble carbohydrate exhibiting a negative heat of solution; (d) optional additional alternating deposits of (b) and (c) above; (e) an optional, powdered deposit of a low-hygroscopic flow agent applied over the powdered layers (b), (c) and (d) where (d) is applied, which low hygroscopic flow agent can be applied after an optional preceding deposit of aqueous solution of water-soluble binder; and (f) an optional layer of protective coating of a confectioner's glaze and/or confectioner's shellac. The present invention is also directed to the process of making the confectionary item.

### RELATED APPLICATION

This application claims priority of Provisional Application Serial No. 60/671,742 filed on Apr. 15, 2006.

### FIELD OF INVENTION

The present invention is directed to the field of confectionaries, specifically, to a syrup free coating on a tackified matrix of gelatin or other hydrocolloid or any other material that can be tackified (hereinafter “matrix”) which is preferably flavored, and which additionally may include an edible carbohydrate, e.g., sugar or polyol such as xylitol on the surface thereof exhibiting a negative heat of solution. Such confectionary products, upon consumption, refresh the palate of the user with a cooling sensation.

### BACKGROUND OF THE INVENTION

Palate-refreshing confections, which generate an endothermic effect in the palate of the user by drawing heat from the oral cavity into the confection, have been prepared with one or more syrups that include agents that effect the endothermic result. Such agents include carbohydrates, e.g., sugars or polyols, such as xylitol, in syrup form.

### SUMMARY OF THE INVENTION

The present invention is directed to a syrup free water soluble coating on a matrix, which may be flavored or unflavored, but which is preferably a flavored matrix, and more preferably, to a syrup free water soluble confectionary item, both of which have a tackified matrix core, which is comprised of a gelatin capsule or solid gelatin or tackified hydrocolloid, or any other material that is capable of being tackified upon which a non-homogenous matrix of components are deposited in sequence, which coating on the confectionary item causes a palate-refreshing, palate-cooling experience in the consumer (e.g., human) when placed in the mouth as a result of an endothermic effect. It is preferred that the matrix core is a tackified matrix core. In a broad aspect, the confectionary item of the present invention comprises;
(a) a tackified matrix core, preferably comprised of a gelatin capsule or solid gelatin or hydrocolloid, upon which a matrix of non-homogenous powdered materials are deposited sequentially as indicated below:
(b) a deposit of binder that adheres to the matrix core, which binder, in a specific aspect of the present invention is preferably gum arabic, which binder deposit may optionally comprise a mixture of binder and an edible water soluble carbohydrate, e.g., polyol, exhibiting a negative heat of solution, which carbohydrate is preferably xylitol;
(c) a powdered deposit of edible carbohydrate, e.g., polyol, exhibiting a negative heat of solution, which carbohydrate is preferably xylitol;
(d) optionally, additional alternate deposits of (b) and (c) above;
(e) optionally, powdered deposits of a low-hygroscopic flow agent applied over the layers (b), (c) and (d) when (d) is applied, which is preferably mannitol, which also is a food grade carbohydrate, e.g., polyol, with negative heat of solution; which low-hygroscopic flow agent can be applied after an optional preceding deposit of an aqueous solution of a water soluble binder, preferably an aqueous solution of gum arabic; and
(f) optionally, a final deposit of a confectioner's glaze and/or confectioner's shellac.

In the above embodiment, it is preferred that the matrix is flavored.

The confectionary product can be prepared in a panning operation. In one aspect of the present invention, if the core is comprised of gelatin, it is tackified by applying thereto an aqueous wetting agent, such as by spraying. “Tackified”, as used herein, means “rendered tacky”. While the aqueous wetting agent may be water, in a specific aspect, the aqueous wetting agent is preferably a solution of a potently sweet sweetener in water. As used herein, a “potently sweet sweetener” is a water soluble sweetener exhibiting a sweetness on the order of at least about 10 times or more, preferably about 50 times or more, and more preferably, about 100 times or more than sucrose, when such sweeteners are compared to a 10% sucrose solution equivalence. The potently sweet sweetener is preferably present at a concentration of at least about 0.1% (w/w), depending on the sweet intensity desired. More preferably, it is present in a concentration ranging from about 0.1% to about 10% (w/w) and more preferably from about 1% to about 10% (w/w).

In a specific aspect of the invention, application of an aqueous wetting agent is applied interspersed between the application of deposits (b), (c) and (d).

A first binder is next deposited on the tackified surface of the tackified matrix core of the confectionary. The binder may optionally contain a water soluble carbohydrate, e.g., polyol, as described hereinabove. A second water soluble carbohydrate, e.g., polyol, having a negative heat of solution is then applied onto the binder. These two steps are optionally repeated, i.e., a binder optionally with carbohydrate, e.g., polyol, is applied onto the carbohydrate, e.g., polyol, layer and carbohydrate, e.g., polyol, is then applied onto the binder. These steps are repeated a desired number of times. Finally, when the alternate layers of binder and carbohydrate, e.g., polyol, are completely added, and no more is to be added, an optional binder layer preferably carbohydrate free, is applied onto the top layer of the carbohydrate. A low hydroscopic agent, preferably mannitol, is optionally applied onto the top thereof. The confectionary product is then dried. Optionally, the entire confectionary item is covered with a shellac or glaze utilizing techniques known to one of ordinary skill in the art.

The foregoing generally describes a palate refreshing confectionary item of the present invention. However, in yet a more specific aspect of the present invention, a flavoring agent or agents will be incorporated into the confectionary item. The flavoring agent may be in the matrix or it may be present in the coating or both. Such flavoring agents may be in liquid form or solid form, and may be applied to the coating as one or more deposits interspersed between application of deposits (b), (c) and (d) or may be present in the tackified core. Solid flavoring agents may be deposited as blends with carbohydrate/binder and optionally with an acidulant, such as citric acid.

As two or more distinct powders and/or powder compositions are deposited onto the confectionary core, it should be understood that powders from a subsequently deposited powder may settle into the interstices present among the powders from a previously deposited powder. What arises is a non-homogenous matrix of material wherein materials intermingle with each other.

“Heat of solution”, as used herein, means “the heat evolved or absorbed when a substance is dissolved in a solvent,” Hawley's Condensed Chemical Dictionary, 14^{th} ed., 2001, incorporated herein by reference. “Negative heat of solution” means that the heat is absorbed when the substance, i.e. the polyol, is dissolved in solution.

By “syrup free”, it is meant that the coating, i.e., the material on top of the core is free of syrup, i.e., free of polyols and sugars, such as glucose, sucrose, fructose, sorbitol, maltitol, xylitol, hydrogenated starch and the like when added via solution.

Quite unexpectedly, the applicants have discovered that a portion of the edible carbohydrate, e.g., polyol, with negative heat of solution is absorbed into the core material, e.g., flavored gelatin capsule. Thus, if the consumer of the confection retains the item in his or her palate past the time of removal of all deposits over the core, he or she will experience yet another incident of endothermic effect.

### BRIEF DESCRIPTION OF THE DRAWING

FIG. 1 is a photograph of a cross-section of an example of the confectionary item of the present invention.

### DETAILED DESCRIPTION OF THE INVENTION

Suitable confectionary cores are those which can be tackified. Any edible product with a surface that can be tackified may be utilized. Examples include bubble gum surfaces; chewing gum surfaces; tableted pieces made from carbohydrate, e.g., polyol; or hydrocolloid, or starch base product, gelatin or other hydrocolloid. In other words, the core itself is comprised of material that can be tackified by adding a tackifying composition thereto or by subjecting the core to physical or chemical processes. For example, a gelatin core can be tackified by applying water or aqueous solution containing a potently sweet sweetener onto the surface thereof, using techniques known to one of ordinary skill in the art. Preferred examples of materials that can be tackified include gelatin capsules, solid gelatin or hydrocolloid as described herein below that can be rendered tacky. It is even more preferred that the core is comprised of a flavored gelatin capsule. Preferably the gelatin cores can be tackified by spraying with water or an aqueous solution containing a potently sweet sweetener. For example, where peppermint flavor is interspersed among deposits (b), (c) and (d), the flavor of the gelatin capsule may also be peppermint flavoring. However, this, in no way, implies that the present invention is to be limited to a unitary flavor selection. The confectionary product may contain more than one flavoring agent.

The capsule may be hollow, the surface of which is tackifiable. The capsule itself is preferably water soluble.

The binding agents that are used such as the one to bind to the edible core in the present invention is an edible binder utilized in the confectionary arts that promotes cohesion between discreet, non-homogenous layers, e.g. the core and the carbohydrate, e.g., polyol. Though gum arabic is well suited as a binding agent, since it both promotes cohesion and is well known as an edible ingredient in food products, other hydrocolloids can be used in whole or in part to replace the gum arabic. The hydrocolloids that can be utilized in the present invention include guar gum, locust bean gum, carageenan, xanthan gum, carboxymethyl cellulose, hydroxypropylmethyl cellulose and the like. The binder may optionally contain a carbohydrate, e.g., polyol, as described herein below, having a negative heat of solution.

It is preferred that the binder is optionally a mixture of a binder agent and a powdered, edible carbohydrate, e.g., polyol, with negative heat of solution. By including the carbohydrate, e.g., polyol, as defined herein below in the mixture, the cooling effect felt by the consumer, e.g. mammal, e.g., human, when the confection is placed in the mouth and/or dissolved in the mouth, becomes enhanced. Although the binder may not contain any carbohydrate, it is preferred that the binder contains at least about 1% carbohydrate, e.g., polyol, and up to about 80% carbohydrate, e.g., polyol, by weight of the binder, and more preferably from about 10% carbohydrate, e.g., polyol, to about 55% by weight carbohydrate, e.g., polyol. One suitable commercially available product is Quick Coat® Xylitol, available from Alfred L. Wolff GmbH, Hamburg, Germany. Quick Coat® Xylitol is believed to be a product including 45% by weight by gum arabic and 55% by weight xylitol.

The edible carbohydrate is a water soluble carbohydrate. It is preferred that it has a solubility of at least about 15 gms in 100 grams of water and more preferably at least about 18 grams in 100 grams of water at 25° C. In addition, the carbohydrate has a negative heat of solution as measured using standard techniques known in the art. It is preferred that the heat of solution of the carbohydrate is greater than −1 Kcal/Kg, i.e. −1 or a higher negative number. To attain a relatively pronounced palate-refreshing effect, the negative value of the heat of solution should be relatively high, that is, as distant from zero as practically possible. The preferred carbohydrates have a negative heat of solution ranging from about −5 Kcal/kg to about −50 Kcal/Kg and more preferably from about −9 kcal/Kg to about −45 Kcal/kg and most preferably from about −20 Kcal/kg to about −45 Kcal/Kg. Third, the carbohydrate outlined is preferably sweet, preferably at least about 40% as sweet as sucrose and more preferably at least about 60% as sweet as sucrose. The preferred carbohydrates are preferably one of the following exemplary carbohydrate or mixtures thereof: sorbitol, mannitol, maltitol, xylitol, lactitol, anhydrous isomalt, and erythritol. Or it may be sugar, e.g., dextrose exhibiting a negative heat of solution.

As used herein, the term “carbohydrate” includes both sugar alcohols and sugars. The preferred carbohydrate is a sugar alcohol. As used term, the term “polyol” is synonymous with sugar alcohol. However, regardless whether the carbohydrate is a sugar or sugar alcohol, the carbohydrate is water soluble and exhibits a negative heat of solution and is preferably sweet.

Xylitol is particularly well suited and preferred because of its relatively high negative heat of solution (−36.5 kcal/kg) and because it is relatively as sweet as sucrose and is highly soluble in water. Combinations of powdered carbohydrates, e.g., polyols, mixed in the same deposit or applied in distinct deposits, may be employed to arrive at the best combination of desired properties.

A carbohydrate, e.g., polyol, layer having a negative heat of solution is next applied over the binder. The carbohydrate, e.g., polyol, utilized has the properties described hereinabove for the carbohydrate, e.g., polyol. The carbohydrate, e.g., polyol, layer may be a mixture of carbohydrates, e.g., polyols, however, it is preferred that it is one carbohydrate, e.g., polyol. Although the carbohydrate, e.g., polyol, in this layer may be different from the carbohydrate, e.g., polyol, that is optionally present in the binder, it is preferred that only one carbohydrate, e.g., polyol, is utilized in the preparation of the product of the present invention.

It is to be noted that the carbohydrate, e.g., polyol, layer is not a continuous layer of carbohydrate, e.g., polyol. The carbohydrate, e.g., polyol, layer consists of carbohydrate, e.g., polyol, that is dispersed heterogeneously but substantially uniformly on the binder layer to form a mesh, i.e., a honeycomb in which the carbohydrate, e.g., polyol, is substantially uniformly distributed.

The confectionary product optionally and more preferably contains additional coats of alternative layers of the binder with or without carbohydrate, and carbohydrate, e.g., polyol. It is preferred that the confectionary product contains at least 5 layers of binder and carbohydrate, e.g., polyol, and more preferably at least 10 layers and most preferably at least 20 layers and most preferably about 20 to about 40 layers and most preferably about 20 to about 25 layers. The identity of the carbohydrate, e.g., polyol, and binder, respectively may be the same or different from the binder and carbohydrate, e.g., polyol, used in the other layers, of the confectionary item, but it is preferred that the binder used in each of the layers is the same and that the carbohydrate used in each layer, including, if optionally present in a mixture with the binder, is the same.

The amount of binder present on each layer is that amount sufficient for the carbohydrate, e.g., polyol, in the next layer to adhere thereto. The amount of carbohydrate, e.g., polyol, totally present is that amount sufficient to create a cooling sensation in the mouth of the consumer, e.g. humans, when the confection is placed in the mouth. The cooling sensation may be realized when the confectionary item is placed in the mouth. For example, it may be realized when the consumer chews or bites into the confectionary item of the present invention. Alternatively, the cooling sensation may be realized when the consumer sucks the confectionary item of the present invention. It is preferred that the product contains from about 1% to about 40% (w/w) of total binder in the coating and more preferably from about 10% to about 30% (w/w) binder in the coating and most preferably from about 15% to about 20% by weight of binder in the coating. It is preferred that the total amount of carbohydrate, e.g., polyol, is present in at least about 1% of the coating and more preferably from about 40% to about 80% by weight of the coating. The weight ratio of carbohydrate, e.g., polyol, to binder in the coating preferably ranges from about 1:1 to about 20:1 and more preferably is at about 8:1.

The top layer of binder may optionally contain a carbohydrate, e.g., polyol therein. However, it is preferred that the top layer contains minimal or no carbohydrate, e.g., less than about 2% by weight carbohydrate, e.g., polyol. The top layer of binder may be applied via aqueous solution.

On top of the top binder layer is an optional layer comprising a material that has a low hygroscopicity, i.e., it is less hygroscopic than glycerin or sorbitol. Examples include mannitol, maltitol, lactitol, isomalt and erythritol. It is preferred that the material of low hygroscopicity is mannitol.

Optionally, this non-hygroscopic material, e.g., mannitol, can be applied over the binder deposit(s) and carbohydrate, e.g., polyol deposit(s), thereby affording a degree of stability and product integrity from the time of manufacture to the time of consumption. This material can be adhered to the product by either the water (or sweetened water) or a binding solution, e.g. gum arabic solution, such as, for example, 10% solution by weight.

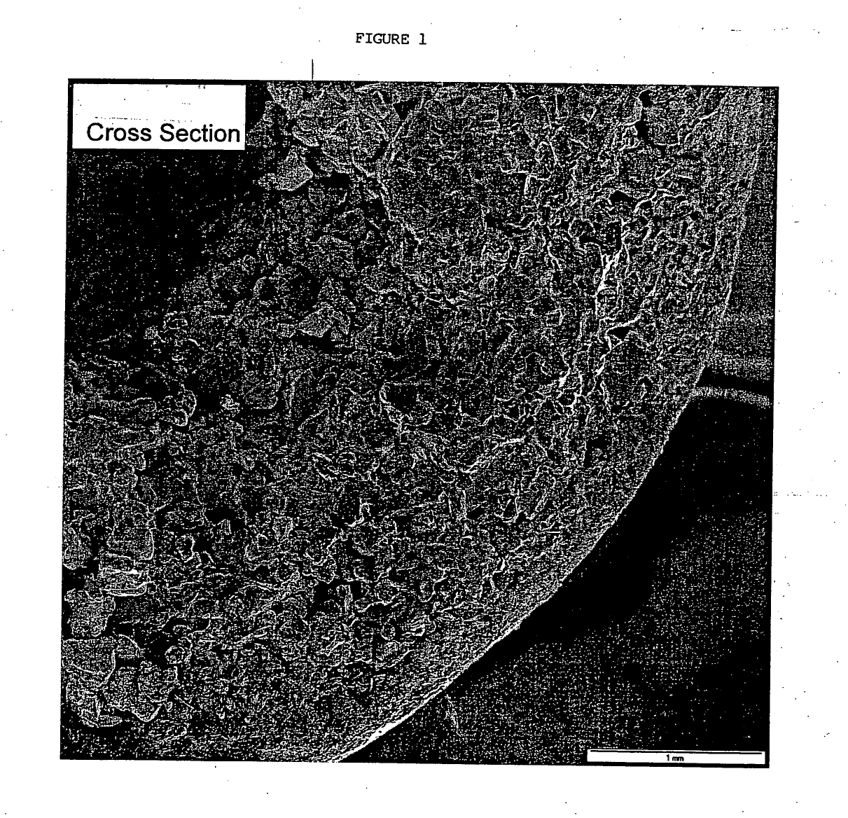

By utilizing this process, the coating that is obtained is not homogenous but is heterogenous, i.e., it is like a honeycomb net having carbohydrate, e.g., polyol, e.g., xylitol, interspersed throughout in a relatively uniform pattern. FIG. 1 is a cross section of confectionary product of the present invention. It illustrates the heterogenisity of the product.

A confectioner's shellac or glaze may be applied over the entire product to protect the tablets and/or to provide a shine or glaze to the confectionary item. Suitable shellacs or glazes include those commonly used in the confectionary art such as cut shellac and glaze.

The product of the present invention is prepared by utilizing techniques known in the art. For example, the core, e.g., gelatin capsule, can be tackified by wetting the gelatin capsule with water, or with an aqueous solution of potently sweet sweetener, as defined hereinabove. In one aspect, the water or aqueous solution can be sprayed onto the core. Preferably, an aqueous solution of a high potency sweeteners soluble in water can be applied. Sufficient water is sprayed onto the core material to make it sufficiently tacky for a binder to be adhered thereto. A preferred suitable aqueous solution of aqueous sweetener is comprised of at least about 0.1% solution (weight/weight basis) of the high potently sweet sweetener, as defined herein and more preferably from about 0.1% to about 10% and even more preferably from about 1% to about 10% by weight of the soluble high potency sweeteners. An example of a potently sweet sweetener is Acesulfame-K. Other potently sweet sweeteners that can be used in solution include: Aspartame, Saccharine, Neotame, Stevioside, Cyclamate, Sucralose, Glycyrrhizin, Alitame, Thaumatin, and the like. Alternatively, the sweetener can be blended with the carbohydrate, e.g., polyol and added dry.

The process of coating the core is effected in a motor driven, revolving pan typically used in the confectionary art. The pan is typically pear or round shaped. The core is placed in the pan and when the pan rotates, the center tumbles on one another providing an excellent mixing and increased surface area.

The alternate additions of binder or binder with carbohydrate, e.g., polyol, to make the material sticky and carbohydrate, e.g., polyol, are added on the surface as the pan is rotating. The process is continued until the desired thickness is obtained and/or until there is no wetting back of the carbohydrate, e.g., polyol. Then optionally additional alternate layers of binder (a binder optionally containing carbohydrate, e.g., polyol) and carbohydrate, e.g., polyol, are added thereto utilizing the same techniques.

The conditions for the additions are quite mild. It can be effected at temperatures ranging from about room temperature to about 100° F., and more preferably from about 40 to about 80° F. and most preferably from about 60 to 70° F. Moreover, the process is affected at low relative humidity, from about 20% to about 60% RH and more preferably from about 30% to about 50% RH.

The process of adding alternate layers of binder and carbohydrate, e.g., polyol, is continued until the desired amount of layers are added. Then a top layer of binder and optionally non-hygroscopic material is added thereto and optionally the shellac coat is added as the top layer utilizing techniques known to one of ordinary skill in the art.

Flavorants are, of course, selected based upon the desired flavor of the end product. Among suitable flavorants, the artisan may select fruit flavor, e.g., raspberry, mint flavors such as peppermint and spearmint, wintergreen, menthol, savory, and sweet flavors such as vanilla, or chocolate, caramel and the like.

A variety of additional optional ingredients can be added to the present compositions to improve one or more properties. Such adjuvants can include, for example, additional flavors, colors, acidulants, vitamins, and the like. Additionally, additives which reduce the growth of microorganisms can be incorporated into the desired coating compositions, especially when the compositions are to be used for providing protective films on external surfaces. Such additives or preservatives include sorbic acid, potassium sorbate, sodium propionate, and propyl p-hydroxybenzoate. The addition of even small concentrations of such preservatives results in a marked improvement in reducing or preventing the growth of microorganisms. In addition, suitable anti-oxidants approved for food can be included in the coating composition. Acidulants optionally added to the confection include citric acid, malic acid, tartaric acid, fumaric acid, and the like.

It should be understood that, in applying layers of binder, in some instances, the layer may substantially be binder only, and in other instances, it may be mixed with edible carbohydrate, e.g., polyol. Also, in some instances, it is desirable to apply binder as an aqueous solution, such for example, a 10% (w/w) gum arabic aqueous solution. Such aqueous binder solutions can be sprayed onto the confections at predetermined times during production.

The applicants have found, that on a weight/weight basis, a preferred ratio of carbohydrate, such as polyol, e.g., xylitol, to mannitol ranges from about 4:1 to about 20:1 and from about 6:1 to about 15:1 and most preferably of about 12:1.

The matrix relative to the finished confectionary item preferably ranges, on a weight/weight basis, from about 4% to about 50%, more preferably from about 6% to about 25%. Binders, such as gum arabic, of the finished confectionary item may comprise by weight about 5% to about 25% of the finished product.

The core may be any shape having a rounded surface, such as by way of example, spheres and cyclinders. It is preferred that the core is spherical with the preferred diameter ranging from about 1 mm to about 10 mm. It is preferred that the core has a diameter of 2 mm to 8 mm, and more preferably 2 mm to 5 mm.

The confectionary product of the present invention also contains water, although the moisture content is low. It ranges from about 1% to about 2% of the coating.

Unless indicated to the contrary, the % is by weight.

Unless indicated to the contrary, the plural connotes the singular and vice versa.

The following examples further illustrate the present invention.

### EXAMPLE 1

SWEET PEPPERMINT/PEPPERMINT

| | GRAMS | % (WT) |
|---|---|---|
| CAPSULE 3.5 MM SWT PEPMNT | 200.0 | 7.84 |
| 3% ACESULFAME-K (ACE-K) | 130 | 5.10 |
| SOLUTION | | |
| (PEPPERMINT LIQ. FLAVOR) | 30 | 1.18 |
| QUICK COAT XYLITOL | 525 | 20.59 |
| XYLITOL | 1462 | 57.33 |
| MANNITOL FINE POWDER | 189 | 7.41 |
| 10% GUM ARABIC SOLUTION | 6 | 0.24 |
| 4 LB GLAZE | 8 | 0.31 |
| TOTAL | 2550.00 | 100.00 |

Procedure:

1. Commence panning—put capsules in ribbed pan and rotate

2. Apply ˜3 Spritz (about 4 gm.) Ace-K solution via atomized spray directly onto capsules. Allow shortdispersion time.

3. Aply Xylitol Quick Coat to coat the capsules.

4. Add Xylitol, the particles which have an average diameter of 170 microns. Stop when a small amount of powder is seen in the pan.

5. Apply ˜3 Spritz Ace-K solution via atomized spray onto capsules.

6. Let the capsules pick up free powder in pan, then add Xylitol till powder is seen in pan.

7. Optionally repeat steps 2, 3, 4, 5 & 6 one or more times.

8. Apply ˜3 Spritz Ace-K solution via atomized spray onto capsules.

9. Apply Xylitol Quick Coat to coat the capsules

10. Add ⅓ liquid flavor.

11. Optionally, repeat steps 2, 3, 4, 5 & 6 one or more times.

12. Apply ˜3 Spritz Ace-K solution via atomized spray directly onto capsules.

13. Apply Xylitol Quick Coat to coat the capsules

14. Add ⅓ liquid flavor.

15. Optionally repeat steps 2, 3, 4, 5 & 6 one or more times.

16. Apply ˜3 Spritz Ace-K solution via atomized spray directly onto capsules.

17. Apply Xylitol Quick Coat to coat the capsules

18. Add ⅓ liquid flavor.

19. Optionally repeat steps 2, 3, 4, 5 & 6 one or more times.

20. Repeat steps 2 & 4 to consume remaining Xylitol.

21. Apply ˜3 Spritz of 10% solution of gum arabic; let disperse.

22. Add mannitol till product is dry.

23. Remove from pan to tray allow to dry overnight at approximately 70 degrees F. & 30-40% RH.

24. Optionally, put material back in pan add 8 grams of the glaze to the pan let disperse with no air.

25. Stop pan turn on air and jog pan for about 3 minutes till dry.

26. Remove from pan to tray allow to dry overnight at approximately 70 degrees F. & 30-40% RH.

### EXAMPLE 2

MENTHOL

| | GRAMS | % (WT) |
|---|---|---|
| CAPSULE 3.5 MM GELATIN MIXED WITH | 200.0 | 7.84 |
| SWEET MENTHOL | | |
| 3% ACE-K SOLUTION | 130 | 5.10 |
| LIQUID MENTHOL | 26 | 1.02 |
| PEPPERMINT | 13 | 0.51 |
| QUICK COAT XYLITOL | 525 | 20.59 |
| XYLITOL | 1461 | 57.29 |
| MANNITOL FINE POWDER | 189 | 7.41 |
| 10% GUM ARABIC SOLUTION | 6 | 0.24 |
| 3.5 CUT SHELLAC DRY WEIGHT | — | — |
| (2 LIQ OUNCES) | | |
| TOTAL | 2550.00 | 100.00 |

Procedure:

1. Commence panning—put capsules in ribbed pan and rotate

2. Apply ˜3 Spritz Ace-K solution via atomized spray onto capsules. Allow short dispersion time.

3. Apply Xylitol Quick Coat to coat the capsules.

4. Add Xylitol the particles of which hae an average diameter of 170 microns. Stop when a small amount of powder is seen in the pan.

5. Apply ˜3 Spritz Ace-K solution via atomized spray directly onto capsules.

6. Let the capsules pick up free powder in pan, then add Xylitol till powder is seen in pan.

7. Optionally repeat steps 2, 3, 4, 5 & 6 one or more times.

8. Apply ˜3 Spritz Ace-K solution via atomized spray directly onto capsules.

9. Apply Xylitol Quick Coat to coat the capsules

10. Add ⅓ liquid flavor.

11. Optionally repeat steps 2, 3, 4, 5 & 6 one or more times.

12. Apply ˜3 Spritz Ace-K solution via atomized spray directly onto capsules.

13. Apply Xylitol Quick Coat to coat the capsules

14. Add ⅓ liquid flavor.

15. Optionally repeat steps 2, 3, 4, 5 & 6 one or more times.

16. Apply ˜3 Spritz Ace-K solution via atomized spray directly onto capsules.

17. Apply Xylitol Quick Coat to coat the capsules.

18. Add ⅓ liquid flavor.

19. Optionally repeat steps 2, 3, 4, 5 & 6 one or more times.

20. Repeat steps 2 & 4 to consume remaining Xylitol.

21. Apply ˜3 Spritz of 10% solution of gum arabic; let disperse.

22. Add mannitol till product is dry.

23. Remove from pan to tray allow to dry overnight at approximately 70 degrees F. & 30-40% RH.

### EXAMPLE 3

RASPBERRY/LEMONADE

| | GRAMS | % (WT) |
|---|---|---|
| CAPSULE 3.5 MM GELATIN MIXED WITH | 200.0 | 7.84 |
| LEMONADE | | |
| 3% ACE-K SOLUTION | 130 | 5.10 |
| CITRIC ACID POWDER | 27 | 1.06 |
| RASPBERRY PWDR | 40 | 1.57 |
| RASPBERRY LIQ FLV | 13 | 0.51 |
| QUICK COAT XYLITOL | 525 | 20.59 |
| XYLITOL | 1420 | 55.69 |
| MANNITOL FINE POWDER | 189 | 7.41 |
| 10% GUM ARABIC | 6 | 0.24 |
| SOLUTION | | |
| GLAZE | — | — |
| TOTAL | 2550.00 | 100.00 |

Procedure:

1. Commence Panning—put capsules in ribbed pan and rotate

2. Apply ˜3 Spritz (about 4 gm.) Ace-K solution via atomized spray directly onto capsules. Allow short dispersion time.

3. Apply Xylitol Quick Coat to coat the capsules.

4. Add Xylitol the particles of which hae an average diameter of 170 microns. Stop when A small amount of powder is seen in the pan.

5. Apply ˜3 Spritz Ace-K solution via atomized spray onto capsules.

6. Let the capsules pick up free powder in pan, then add Xylitol till powder is seen in pan.

7. Optionally repeat steps 2, 3, 4, 5 & 6 one or more times.

8. Apply ˜3 Spritz Ace-K solution via atomized spray onto capsules.

9. Apply Xylitol Quick Coat to coat the capsules

10. Add ⅓ flavor/Xylitol/acid blend.

11. Optionally, repeat steps 2, 3, 4, 5 & 6 one or more times.

12. Apply ˜3 Spritz Ace-K solution via atomized spray directly onto capsules.

13. Apply Xylitol Quick Coat to coat the capsules

14. Add ⅓ flavor/Xylitol/acid blend.

15. Optionally repeat steps 2, 3, 4, 5 & 6 one or more times.

16. Apply ˜3 Spritz Ace-K solution via atomized spray directly onto capsules.

17. Apply Xylitol Quick Coat to coat the capsules

18. Add ⅓ flavor/Xylitol/acid blend.

19. Optionally repeat steps 2, 3, 4, 5 & 6 one or more times.

20. Apply ˜3 Spritz Ace-K solution via atomized spray onto capsules.

21. Apply Xylitol Quick Coat to coat the capsules.

22. Add 10 grams of liquid raspberry flavor.

23. Apply ˜3 Spritz Ace-K solution via atomized spray onto capsules.

24. Apply Xylitol Quick Coat to coat the capsules

25. Add 3 grams of liquid raspberry flavor.

26. Repeat steps 2 & 4 to consume all Xylitol.

27. Apply ˜3 Spritz of 10% solution of gum arabic; let disperse.

28. Add all of the mannitol till product is dry.

29. Remove from pan to tray allow to dry overnight at approximately 70 degrees F. & 30 -40% RH.

### EXAMPLE 4

SWEET MENTHOL/RASPBERRY

| | GRAMS | % (WT) |
|---|---|---|
| CAPSULE 3.5 MM GELATIN MIXED WITH | 200.0 | 7.84 |
| MENTHOL | | |
| 3% ACE-K SOLUTION | 130 | 5.10 |
| CITRIC ACID POWDER | 27 | 1.06 |
| RSPBRY PWDR | 40 | 1.57 |
| RSPBRY LIQ | 13 | 0.51 |
| QUICK COAT XYLITOL | 525 | 20.59 |
| XYLITOL | 1420 | 55.69 |
| MANNITOL FINE POWDER | 189 | 7.41 |
| 10% GUM ARABIC SOLUTION | 6 | 0.24 |
| 3.5 CUT SHELLAC DRY WEIGHT | — | — |
| (2 LIQ OUNCES) | | |
| TOTAL | 2550.00 | 100.00 |

Procedure

1. Commence panning—put capsules in ribbed pan and rotate

2. Apply ˜3 Spritz (about 4 gm.) Ace-K solution via atomized spray directly onto capsules. Allow short dispersion time.

3. Apply Xylitol Quick Coat to coat the capsules.

4. Add Xylitol, the particles of which have an average of 170 microns. Stop when a small amount of powder is seen in the pan.

5. Apply ˜3 Spritz Ace-K solution via atomized spray onto capsules.

6. Let the capsules pick up free powder in pan, then add Xylitol till powder is seen in pan.

7. Optionally repeat steps 2, 3, 4, 5 & 6 one or more times.

8. Apply ˜3 Spritz Ace-K solution via atomized spray onto capsules.

9. Apply Xylitol Quick Coat to coat the capsules

10. Add ⅓ powder flavor/Xylitol/acid blend

11. Optionally, repeat steps 2, 3, 4, 5 & 6 one or more times.

12. Apply ˜3 Spritz Ace-K solution via atomized spray directly onto capsules.

13. Apply Xylitol Quick Coat to coat the capsules

14. Add ⅓ powder flavor/Xylitol/acid blend.

15. Optionally repeat steps 2, 3, 4, 5 & 6 one or more times.

16. Apply ˜3 Spritz Ace-K solution via atomized spray directly onto capsules.

17. Apply Xylitol Quick Coat to coat the capsules

18. Add ⅓ flavor/Xylitol/acid blend.

19. Optionally repeat steps 2, 3, 4, 5 & 6 one or more times.

20. Apply ˜3 Spritz Ace-K solution via atomized spray onto capsules.

21. Apply Xylitol Quick Coat to coat the capsules.

22. Add 10 grams of liquid raspberry flavor.

23. Apply ˜3 Spritz Ace-K solution via atomized spray onto capsules.

24. Apply Xylitol Quick Coat to coat the capsules

25. Add 3 grams of liquid raspberry flavor.

26. Repeat steps 2 & 4 to consume all Xylitol.

27. Apply ˜3 Spritz of 10% solution of gum arabic; let disperse.

28. Add all of the mannitol till product is dry.

29. Remove from pan to tray allow to dry overnight at approximately 70 degrees F. & 30-40% RH.

### EXAMPLE 5

SWEET PEPPERMINT CAPSULE

| | GRAMS | % (WT) |
|---|---|---|
| GELATIN CAPSULE (5.0 mm) MIXED WITH | 300 | 51.81 |
| PEPMNT CAPSULE | | |
| WATER | 15 | 2.59 |
| PEPPERMINT | 1 | 0.17 |
| 50/50 BLEND OF 90 MICRONS AND | 260 | 44.91 |
| 170 MICRONS XYLITOL | | |
| (AVG. PARTICLE SIZE) | | |
| 10% GUM ARABIC SOLUTION | 3 | 0.52 |
| TOTAL | 579 | 100.00 |

Procedure:

1. Commence panning—put capsules in ribbed pan and rotate

2. Apply ˜3 mls water via atomized spray onto capsules.

3. Let the water disperse onto capsules.

4. Apply sufficient Xylitol blend to coat the capsules. Add till powder is seen in pan.

5. Apply ˜3 mls water via atomized spray directly onto capsules.

6. Tumble capsules to pick up free Xylitol in pan, then repeat step 4.

7. Add flavor.

8. Repeat steps 5 & 6 until about 50 grams of Xylitol is a left.

9. Apply ˜3 gms of 10% solution of gum arabic; let disperse.

10. Add remaining amount of Xylitol blend.

11. Remove from pan to tray allow to dry overnight.

### EXAMPLE 6

PEPPERMINT CAPSULE WITH QUICK COAT MATERIAL
IN COATING & SPRAY DRIED FLAVOR

| | ESTIMATED @ 75% COAT | | | |
|---|---|---|---|---|
| | RASPBERRY No. 1 | | RASPBERRY No. 2 | |
| | GRAMS | % | GRAMS | % |
| GELATIN CAPSULE MIXED | 200.0 | 25.00 | 200.0 | 25.00 |
| SWEET PPMNT CAPLS 3.5 MM | | | | |
| WATER | 24.0 | 3.00 | 24.0 | 3.00 |
| CITRIC ACID | 8.0 | 1.00 | 8.0 | 1.00 |
| ACE-K | 0.8 | 0.10 | 0.8 | 0.10 |
| RSPBRY PWDR No. 1 | 8.0 | 1.00 | — | — |
| RSPBRY PWDR No. 2 | — | — | 8.0 | 1.00 |
| QUICK COAT XYLITOL | 120.0 | 15.00 | 120.0 | 15.00 |
| 50/50 BLEND OF 90 MICRONS AND | 371.0 | 46.38 | 371.0 | 46.38 |
| 170 MICRONS XYLITOL (AVG. PARTICLE SIZE) | | | | |
| MANNITOL FINE POWDER | 64.0 | 8.00 | 64.0 | 8.00 |
| 10% GUM ARABIC SOLUTION | 4.1 | 0.52 | 4.1 | 0.52 |
| TOTAL | 800.0 | 100.00 | 800.0 | 100.00 |

Procedure:

1 Commence panning—put capsules in ribbed pan and rotate

2. Apply ˜3 Spritz water via atomized spray directly onto capsules.

3. Let the water disperse onto all capsules.

4. Apply ˜12% Xylitol Quick Coat to coat the capsules and continue to apply till powder is seen in pan.

5. Apply ˜3 mls water via atomized spray directly onto capsules.

6. Let the capsules pick up free powder in pan, when this is done add enough Xylitol blend till powder is sen in pan.

7. Optionally, repeat steps 3, 4, 5 & 6 one or more times.

8. Add ½ flavor and ½ Xylitol acid blend.

9. Optionally, repeat steps 3, 4, 5 & 6 one or more times.

10. Repeat steps 3, 4, 5 & 6 till sunstantially no Xylitol is left.

11. Apply ˜3 gms of 10% solution of gum arabic; let disperse.

12. Add mannitol.

13. Remove from pan to tray allow to dry overnight.

### EXAMPLE 7

| | GRAMS | % |
|---|---|---|
| GELATIN CAPSULE MIXED WITH | 200.0 | 12.50 |
| SWEET PPMNT CAPLS 3.5 MM | | |
| 3% ACE-K SOLUTION | 68.0 | 4.25 |
| CITRIC ACID | 16.0 | 1.00 |
| RSPBRY PWDR | 16.0 | 1.00 |
| RSPBRY LIQ FLV | 4.5 | 0.28 |
| QUICK COAT XYLITOL | 309.6 | 19.35 |
| 50/50 BLEND OF 90 MICRONS & 170 | 848.0 | 53.00 |
| MICRONS XYLITOL (AVG. PARTICLE SIZE) | | |
| MANNITOL FINE POWDER | 128.0 | 8.00 |
| 10% GUM ARABIC SOLUTION | 9.9 | 0.62 |
| TOTAL | 1600.0 | 100.00 |

Procedure:

1. Commence panning—put capsules in ribbed pan and rotate

2. Apply ˜3 Spritz Ace-K solution via atomized spray directly onto capsules.

3. Let the water disperse onto all capsules.

4. Quickly apply ˜10% Xylitol Quick Coat to coat the capsules then apply Xylitol blend till powder is seen in pan.

5. Apply ˜3 Spritz Ace-K solution via atomized spray onto capsules

6. Let the capsules pick up free powder in pan, when this is done add enough Xylitol blend till powder is seen in pan.

7. Optionally, repeat steps 2, 3, 4, 5 & 6 one or more times.

8. Apply ˜3 Spritz Ace-K solution via atomized spray directly onto capsules.

9. Quickly apply ˜12% Xylitol Quick Coat to coat the capsules then

10. Add ⅓ flavor, Xylitol acid blend.

11. Optionally repeat steps 2, 3, 4, 5 & 6 one or more times.

12. Apply ˜3 Spritz Ace-K solution via atomized spray directly onto capsules.

13. Quickly apply ˜12% Xylitol Quick Coat to coat the capsules then

14. Add ⅓ flavor, Xylitol acid blend.

15. Optionally repeat steps 2, 3, 4, 5 & 6 one or more times.

16. Apply ˜3 Spritz Ace-K solution via atomized spray directly onto capsules.

17. Quickly apply ˜12% Xylitol Quick Coat to coat the capsules then

18. Add ⅓ flavor, Xylitol acid blend.

19. Optionally repeat steps 5 & 6 one or more times.

20. Add 4.4 grams of liquid raspberry flavor.

21. Repeat steps 5 & 6 until Xylitol is consumed.

22. Apply ˜3 Spritz of 10% solution of gum arabic; let disperse.

23. Quickly add all of the mannitol gradually till product is dry.

24. Remove from pan to tray allow to dry overnight at approximately 70 degrees F. & 30-40% RH.

### EXAMPLE 8

SWEET PEPPERMINT CAPSULE WITH QUICK COAT
MATERIAL IN COATING

| | GRAMS | % |
|---|---|---|
| GELATIN CAPSULE CONTAINING SWEET | 200.0 | 12.50 |
| PEPPMNT 3.5 MM | | |
| 3% ACE-K SOLUTION | 68.0 | 4.25 |
| FRNCH VANILLA FLAVOR | 24.0 | 1.50 |
| PEPPERMINT | 4.0 | 0.25 |
| QUICK COAT XYLITOL (4.5% Gum arabic/ | 318.1 | 19.88 |
| 55% xylitol) | | |
| 50/50 BLEND OF 90 MICRONS AND 170 | 848.0 | 53.00 |
| MICRONS XYLITOL (AVG. PARTICLE SIZE) | | |
| MANNITOL FINE POWDER | 128.0 | 8.00 |
| 10% GUM ARABIC SOLUTION | 9.9 | 0.62 |
| TOTAL | 1600.0 | 100.00 |

1. Commence panning—put capsules in ribbed pan and rotate.

2. Apply ˜3 Spritz Ace-K solution via atomized spray directly onto capsules.

3. Let the water disperse onto all capsules.

4. Quickly apply ˜10% Xylitol Quick Coat to coat the capsules then apply Xylitol blend until powder is seen in pan.

5. Apply ˜3 Spritz Ace-K solution via atomized spray directly onto capsules.

6. Let the capsules pick up free powder in pan, when this is done add enough Xylitol blend till powder is seen in pan.

7. Optionally repeat steps 2, 3, 4, 5 & 6 one or more times.

8. Apply ˜3 Spritz Ace-K solution via atomized spray directly onto capsules.

9. Quickly apply ˜12% Xylitol Quick Coat to coat the capsules then

10. Add ⅓ flavor, Xylitol acid blend.

11. Optionally repeat steps 2, 3, 4, 5 & 6 one or more times.

12. Apply ˜3 Spritz Ace-K solution via atomized spray directly onto capsules.

13. Quickly apply ˜12% Xylitol Quick Coat to coat the capsules then

14. Add ⅓ flavor, Xylitol acid blend.

15. Optionally repeat steps 2, 3, 4, 5 & 6 one or more times.

16. Apply ˜3 Spritz Ace-K solution via atomized spray directly onto capsules.

17. Quickly apply ˜12% Xylitol Quick Coat to coat the capsules then

18. Add ⅓ flavor, Xylitol acid blend.

19. Optionally repeat steps 5 & 6 one or more times.

20. Add 4.4 grams of liquid raspberry flavor.

21. Repeat steps 5 & 6 until Xylitol is consumed.

22. Apply ˜3 Spritz of 10% solution of gum arabic; let disperse.

23. Quickly Add all of the mannitol gradually till product is dry.

24. Remove from pan to tray allow to dry overnight at approximately 70 degrees F. & 30-40% RH.

### EXAMPLE 9

3.5 MM CAPSULES MIDPOINT 2300 GM PAN WEIGHT

| | GRAMS | % |
|---|---|---|
| GELATIN CAPSULES | 200.0 | 8.52 |
| (3.5 mm) | | |
| 3% ACE-K SOLUTION | 119 | 5.07 |
| CITRIC ACID | 25 | 1.07 |
| RSPBRY PWDR | 25 | 1.07 |
| RSPBRY LIQ FLV | 7 | 0.30 |
| QUICK COAT XYLITOL | 480 | 20.45 |
| 50/50 BLEND OF 90 MICRONS AND | 1313 | 55.94 |
| 170 MICRONS XYLITOL (AVG. | | |
| PARTICLE SIZE) | | |
| MANNITOL FINE POWDER | 173 | 7.37 |
| 10% GUM ARABIC SOLUTION | 5 | 0.21 |
| TOTAL | 2347.00 | 100.00 |

Procedure:

1. Commence panning—put capsules in ribbed pan and rotate.

2. Apply ˜3 Spritz Ace-K solution via atomized spray directly onto capsules.

3. Let the water disperse onto all capsules.

4. Quickly apply ˜10% Xylitol Quick Coat to coat the capsules then apply Xylitol blend till powder is seen in pan.

5. Apply ˜3 Spritz Ace-K solution via atomized spray directly onto capsules.

6. Let the capsules pick up free powder in pan, when this is done add enough Xylitol blend till powder is sen in pan.

7. Optionally repeat steps 2, 3, 4, 5 & 6 one or more times.

8. Apply ˜3 Spritz Ace-K solution via atomized spray directly onto capsules.

9. Quickly apply ˜12% Xylitol Quick Coat to coat the capsules then

10. Add ⅓ flavor, Xylitol acid blend.

11. Optionally repeat steps 2, 3, 4, 5 & 6 one or more times.

12. Apply ˜3 Spritz Ace-K solution via atomized spray directly onto capsules.

13. Quickly apply ˜12% Xylitol Quick Coat to coat the capsules then

14. Add ⅓ flavor, Xylitol acid blend.

15. Optionally repeat steps 2, 3, 4, 5 & 6 one or more times.

16. Apply ˜3 Spritz Ace-K solution via atomized spray directly onto capsules.

17. Quickly apply ˜12% Xylitol Quick Coat to coat the capsules then

18. Add ⅓ flavor, Xylitol, acid blend.

19. Optionally repeat steps 5 & 6 one or more times

20. Add 4.4 grams of liquid raspberry flavor.

21. Repeat steps 5 & 6 until Xylitol is consumed.

22. Apply ˜3 Spritz of 10% solution of gum arabic; let disperse.

23. Quickly add all of the mannitol gradually till product is dry.

24. Remove from pan to tray allow to dry overnight at approximately 70 degrees F. & 30-40% RH.

EXAMPLE 10
SWEET PEPPERMINT CAPSULE WITH FRUIT FLAVORS IN COATING

| | ORANGE #1 | | ORANGE #1 | | RASPBERRY #1 | | RASPBERRY #2 | | PINEAPPLE | |
|---|---|---|---|---|---|---|---|---|---|---|
| | GRAMS | % | GRAMS | % | GRAMS | % | GRAMS | % | GRAMS | % |
| 1. CURRENT PPMNT CAPSULES, | 300.0 | 51.64 | 300.0 | 51.66 | 300.0 | 51.72 | 300.0 | 51.67 | 300.0 | 51.71 |
| 5 mm | | | | | | | | | | |
| 2. RT WATER | 15.0 | 2.58 | 15.0 | 2.58 | 15.0 | 2.58 | 15.0 | 2.58 | 15.0 | 2.58 |
| 3. CITRIC ACID | 4.1 | 0.70 | — | — | 1.7 | 0.30 | 3.5 | 0.60 | 1.7 | 0.30 |
| 4. ACE-K | 0.6 | 0.10 | 0.6 | 0.10 | 0.6 | 0.10 | 0.6 | 0.10 | 0.6 | 0.10 |
| 5. ORANGE # 1 | 4.4 | 0.75 | 2.9 | 0.50 | — | — | — | — | — | — |
| 6. ORANGE # 2 | — | — | — | — | — | — | — | — | — | — |
| 7. RASPBERRY # 1 | — | — | 4.2 | 0.72 | 1.5 | 0.25 | — | — | — | — |
| 8. RASPBERRY # 2 | — | — | — | — | — | — | 3.5 | 0.60 | — | — |
| 9. PINEAPPLE | — | — | — | — | — | — | — | — | 0.9 | 0.15 |
| 10. CITRUS BLEND | — | — | — | — | — | — | — | — | 0.9 | 0.15 |
| 11. 50/50 BLEND OF 90 MICRONS | 203.9 | 35.10 | 205.1 | 35.31 | 208.4 | 35.92 | 205.1 | 35.32 | 208.1 | 35.88 |
| AND 170 MICRONS XYLITOL | | | | | | | | | | |
| (AVG. PARTICLE SIZE) | | | | | | | | | | |
| 12. MANNITOL FINE POWDER | 50.0 | 8.61 | 50.0 | 8.61 | 49.9 | 8.61 | 50.0 | 8.61 | 50.0 | 8.61 |
| 13. 10% GUM ARABIC SOLUTION | 3.0 | 0.52 | 3.0 | 0.52 | 3.0 | 0.52 | 3.0 | 0.52 | 3.0 | 0.52 |
| TOTAL | 580.95 | 100.00 | 580.72 | 100.00 | 580.05 | 100.00 | 580.7 | 100.00 | 580.1 | 100.00 |

Procedure:

1. Commence panning—put capsules in ribbed pan and rotate.

2. Apply approx. 3 mls water via atomized spray directly onto capsules.

3. Let the water disperse onto all capsules.

4. Apply sufficient amount of Xylitol blend to coat the capsules. Continue to apply Xylitol until powder is seen in pan.

5. Apply approx. 3 mls water via atomized spray directly onto capsules.

6. Let the capsules pick up free Xylitol in pan. repeat step #4.

7. Add selected flavor.

8. Repeat steps 5 & 6 until substantially all Xylitol is gone.

9. Apply approx. 3 gms of 10% solution of gum arabic. Let disperse.

10. Add mannitol.

11. Remove from pan to tray allow to dry overnight.

### EXAMPLE 11

SWEET PEPPERMINT CAPSULE WITH QUICK COAT
MATERIAL IN COATING & SPRAY DRIED FLAVOR

| | ESTIMATED @ 85% | |
|---|---|---|
| | COAT | |
| | GRAMS | % |
| SWEET PPMNT CAPLS 3.5 MM | 199.9 | 14.28 |
| 3% ACE-K SOLUTION | 47.9 | 3.42 |
| CITRIC ACID | 16.0 | 1.14 |
| RASPBERRY POWDER | 16.0 | 1.14 |
| RASPBERRY LIQ FLAVOR | 4.3 | 0.31 |
| QUICK COAT XYLITOL | 238.0 | 17.00 |
| 50/50 BLEND OF 90 MICRONS AND | 742.0 | 53.00 |
| 170 MICRONS XYLITOL (AVG. PARTICLE | | |
| SIZE) | | |
| MANNITOL FINE POWDER | 127.8 | 9.13 |
| 10% GUM ARABIC SOLUTION | 8.1 | 0.58 |
| TOTAL | 1400.0 | 100.00 |

Procedure:

1. Commence panning—put capsules in ribbed pan and rotate.

2. Apply about 3 Spritz Ace-K solution via atomized spray directly onto capsules.

3. Let the water disperse onto all capsules.

4. Quickly apply about 10% Xylitol Quick Coat to coat the capsules then apply Xylitol blend till powder is seen in pan.

5. Apply about 3 Spritz Ace-K solution via atomized spray directly onto capsules.

6. Let the capsules pick up free powder in pan, when this is done add enough Xylitol blend till powder is seen in pan.

7. Optionally repeat steps 2, 3, 4, 5 & 6 one or more times

8. Apply ˜3 Spritz Ace-K solution via atomized spray directly onto capsules.

9. Quickly apply ˜12% Xylitol Quick Coat to coat the capsules then

10. Add ⅓ flavor, Xylitol acid blend.

11. Optionally repeat steps 2, 3, 4, 5 & 6 one or more times

12. Apply ˜3 Spritz Ace-K solution via atomized spray directly onto capsules.

13. Quickly apply ˜12% Xylitol Quick Coat to coat the capsules then

14. Add ⅓ flavor, Xylitol acid blend.

15. Optionally repeat steps 2, 3, 4, 5 & 6 one or more times

16. Apply ˜3 Spritz Ace-K solution via atomized spray directly onto capsules.

17. Quickly apply ˜12% Xylitol Quick Coat to coat the capsules then

18. Add ⅓ flavor, Xylitol, acid blend.

19. Repeat steps 5 & 6 one or more times.

20. Add 4.4 grams of liquid raspberry flavor.

21. Repeat steps 5 & 6 until Xylitol is consumed.

22. Apply ˜3 Spritz of 10% solution of gum arabic; let disperse.

23. Add mannitol gradually until product is dry.

24. Remove from pan to tray allow to dry overnight at approximately 70 degrees F. & 30-40% RH.

What is claimed is:

1. A confectionery item for oral consumption by consumer, comprised of a tackified core, and a coating entirely covering the core, said coating comprised of (a) a first layer comprised of a first binding agent substantially uniformly coating said core, said binding agent being present in quantities sufficient to promote cohesion between the core and an edible water soluble first carbohydrate; (b) a second layer comprised of an edible water soluble first carbohydrate exhibiting a negative heat of solution, said first carbohydrate being dispersed heterogeneously but substantially uniformly in said second layer; (c) a plurality of alternate layers comprised of a second binder and an edible water soluble second carbohydrate, exhibiting a negative heat of solution, said second binding agent and second carbohydrate being arranged to form a honeycomb mesh of alternative layers of said second binder and second carbohydrate, the amount of second binding agent being present in quantities sufficient for the carbohydrate in the next layer to adhere thereto, said layer comprising the second binding agent being the bottom and top layer of the alternating layers and said second carbohydrate exhibiting a negative heat of solution, wherein each of the second binders in the alternative layer may be the same or different and wherein the identity of each of the second carbohydrates may be the same or different; (d) an optional layer covering the alternative layer comprised of a low hygroscopic agent having a hygroscopicity value less than that of glycerin and sorbitol; and (e) optionally a top layer covering the confectionery item comprised of a confectioner's shellac or confectioner's glaze wherein the total amount of all of the carbohydrate present in the coating is in sufficient quantities to create a cooling sensation when said item is placed in the mouth of consumers.

2. The confectionary item according to claim 1 wherein the core is comprised of gelatin capsule, solid gelatin or hydrocolloid.

3. The confectionary item of claim 1 wherein the matrix core is flavored.

4. The confectionary item of claim 3 wherein the flavored matrix core is comprised of flavored gelatin capsule.

5. The confectionary item of claim 1 wherein the first binding agent also contains a water soluble third carbohydrate having a negative heat of solution.

6. The confectionary term of claim 5 wherein the water soluble carbohydrate is present in amounts ranging from about 1% to about 80% by weight of the binding agent.

7. The confectionary item of claim 5 wherein the first carbohydrate, each of the second carbohydrates and the third carbohydrate are the same.

8. The confectionary item of claim 1 wherein the first and each of the second binding agents are the same.

9. The confectionary item of claim 7 where the first and each of the second binding agents are the same.

10. The confectionary item of claim 9 wherein the first and each of the second binding agents are hydrocolloids or hydrocolloids containing one water soluble carbohydrate having a negative heat of solution.

11. The confectionary item of claim 10 wherein the first and second binding agents are both gum arabic, guar gum, locust bean gum, carageenan, xanthan gum, carboxymethyl cellulose or hydroxypropyl methyl cellulose, and wherein they optionally contain one water soluble carbohydrate having a negative heat solution.

12. The confectionary item according to claim 11 wherein the first and second binding agents are both gum arabic, each optionally containing a water soluble carbohydrate having a negative heat of solution.

13. The confectionary item according to claim 9 wherein the first, second and third carbohydrates have a negative heat of solution ranging from about −5 kcal/kg to about −50 kcal/kg.

14. The confectionary item according to claim 13 wherein the first, second and third carbohydrates are the same and are sorbitol, mannitol, maltitol, xylitol, anhydrous isomalt, erythritol, dextrose or a mixture thereof.

15. The confectionary item of claim 14 wherein the first, second and third carbohydrates are xylitol.

16. The confectionary item of claim 13 wherein the confectionary item is comprised of at least 5 layers comprising said carbohydrate and at least 5 layers comprising said binding agent and optionally containing said water soluble carbohydrate.

17. The confectionary item according to claim 16 where the confectionary item is comprised of at least about 20 layers of said carbohydrate and said binding agent optionally containing said carbohydrate.

18. The confectionary item according to claim 17 wherein the confectionary item is comprised of at least about 20 to about 40 layers of said carbohydrate and said binding agent optionally containing said water soluble carbohydrate.

19. The confectionary item according to claim 8 wherein the coating is comprised from about 12% to about 40% (w/w) of said binding agent.

20. The confectionary item according to claim 19 wherein the coating contains from about 10% to about 30% (w/w) of said binding agent.

21. The confectionary item according to claim 20 wherein the coating is comprised from about 15% to about 20% (w/w) of said binding agent.

22. The confectionary item according to claim 8 wherein the coating comprises about 40% to about 80% (w/w) of said carbohydrate.

23. The confectionary item according to claim 6 wherein the weight ratio of said carbohydrate to said binding agent in the coating ranges from about 7:1 to about 20:1.

24. The confectionary item of claim 1 wherein the optional layer comprised of the low hygroscopic agent is present and the agent having a low hygroscopicity is mannitol, maltitol, lactitol, isomalt or erythritol.

25. The confectionary item of claim 24 wherein the agent having a low hygroscopicity is mannitol.

26. The confectionary item of claim 1 wherein the top layer comprised of confectioner's shellac or glaze.

27. The confectionary item of claim 24 wherein the top layer comprised of confectioner's shellac or glaze is present.

28. The confectionary item according to claim 1 wherein the core is tackified by applying thereto an aqueous solution of potently sweet sweetener, water or carbohydrate.

29. The confectionary item according to claim 28 wherein the matrix is tackified by applying an aqueous solution comprised of at least 0.1% potentially sweet sweetener.

30. The confectionary item according to claim 29 wherein the potentially sweet sweetener is acesulfame-K, aspartame, saccharine, neotame, stevioside, cyclamate, sucralose, glycyrrhizin, alitame, or thaumatin, or mixture thereof.

31. The confectionary item according to claim 9 wherein the coating additionally comprises a potentially sweet sweetener, an anti-oxidant, a coloring agent, acidulant, vitamin, or preservative or mixture thereof.

32. The confectionary item according to claim 1 comprised of a gelatin flavored gelatin capsule coated with a binding agent comprised of gum arabic and xylitol, a polyol coating thereon comprised of xylitol, alternate layers of said polyol and binding agent being applied thereon until the desired thickness is obtained, and an outer layer comprised of mannitol.

33. The confectionary item according to claim 32 wherein the coating contains from about 20 to about 40 layers of said binding agent and said polyol.

34. The confectionary item of claim 32 wherein the weight ratio of xylitol to mannitol ranges from about 4:1 to about 12:1.

35. A confectionary item for consumption prepared by a method comprising
a. preparing a tackified matrix core; and
b. coating the core by (1) applying a layer comprised of a first binding agent onto the surface of the core, said binding agent substantially uniformly coating the core, said binding agent being present in sufficient amounts to bind the first carbohydrate thereto; (2) applying substantially uniformly on said first layer a second layer comprised of a powdered deposit of an edible water soluble carbohydrate exhibiting a negative heat of solution; (3) applying substantially uniformly onto the product of (2) alternate layers of a second binding agent and a water soluble second carbohydrate exhibiting a negative heat of solution, said alternate layers being applied substantially uniformly thereon to form a honeycombed mesh structure comprised of an alternate layers of said binding agent and said carbohydrate, the topmost layer and said bottommost layer thereof being a layer comprising said second binding agent, respectively, the binding agent being present in sufficient amounts to bind the carbohydrate in the next layer thereto wherein each of the second binding agents are the same or different and each of the second carbohydrates are the same or different and (4) optionally applying substantially uniformly on the product of (3), a layer comprising a low hygroscopic flow agent;
c. optionally coating the product of step (b) with a confectioner's glaze or confectioner's shellac, the carbohydrates in total being present in the coating in amounts sufficient to create a cooling sensation when said confectionary item is placed in the mouth.

36. The confectionary item according to claim 35 wherein a third carbohydrate is present in either the first binding agent or in at least one of the second binding agents.

37. The confectionary item of claim 35 wherein the first and each of the second binding agents are the same.

38. The confectionary item according to claim 36 where the first and each of the second carbohydrates and the third carbohydrates are the same.

39. The confectionary item according to claim 37 where the first and each of the second carbohydrates are the same.

40. The confectionary item of claim 38, wherein each of the binding agents additionally contain a third carbohydrate which third carbohydrate is the same as the first and second carbohydrates.

41. The confectionary item according to claim 39 where the core is comprised of a hydrocolloid or gelatin.

42. The confectionary item according to claim 41 wherein the core is comprised of a flavored gelatin capsule.

43. The confectionary item according to claim 42 where the flavored gelatin capsule is tackified by application of a wetting agent thereto selected from the group consisting of water and aqueous solution of a potently sweet sweetener.

44. The confectionary item according to claim 43 where the flavored gelatin capsule is tackified by application of an aqueous solution comprising at least 0.1% weight of a potently sweet sweetener.

45. The confectionary item according to claim 39 where the binder is gum arabic.

46. The confectionary item according to claim 35 wherein the first and each of the second binders are comprised of a mixture of gum arabic and a water soluble third carbohydrate having a negative heat of solution.

47. The confectionary item of claim 46 when the first carbohydrate and each of the second carbohydrates and the third carbohydrate are the same.

48. The confectionary item of claim 40 wherein the first carbohydrate, each of the second carbohydrate and third carbohydrate are sorbitol, mannitol, maltitol, xylitol, lactitol, anhydrous isolmalt, erythritol or an mixture thereof.

49. The confectionary item of claim 48 wherein the first, each of the second and third polyols are xylitol.

50. The confectionary item of claim 47 wherein the coating additionally comprises at least 1% potently sweet sweetener.

51. The confectionary item of claim 47 wherein the coating additionally comprises a flavoring agent.

52. The confectionery item of claim 47 wherein the low hygroscopic flowing agent is present

53. The confectionary item of claim 52 wherein the low hygroscopic flowing agent is mannitol.

54. The confectionary item of claim 37 containing at least 5 layers comprising said binding agent and 5 layers comprising said carbohydrate.

55. The confectionary item according to claim 54 containing from about 20 to about 40 layers comprised of a said binding agent and said carbohydrate.

56. The confectionary item according to claim 47 wherein the coating is comprised from about 10% to about 40% (w/w) of said binding agent.

57. The confectionary item according to claim 56 wherein the coating contains from about 10% to about 30% (w/w) of said binding agent.

58. The confectionary item according to claim 47 wherein the coating comprises about 40% to about 80% (w/w) of said carbohydrate to said binding agent in the coating ranges from about 7:1 to about 20:1.
